(19) United States
(12) Patent Application Publication
(10) Pub. No.: US 2023/0372816 A1
(43) Pub. Date: Nov. 23, 2023

(54) INFORMATION PROCESSING DEVICE, INFORMATION DISPLAYING METHOD, AND SERVER DEVICE

(71) Applicant: SONY INTERACTIVE ENTERTAINMENT INC., TOKYO (JP)

(72) Inventors: Yasuo SASAKI, TOKYO (JP); Nobuyuki NAKAMURA, TOKYO (JP)

(21) Appl. No.: 18/027,674

(22) PCT Filed: Sep. 24, 2021
(86) PCT No.: PCT/JP2021/034957

§ 371 Date: Mar. 22, 2023

(30) Foreign Application Priority Data
Sep. 30, 2020 (JP) 2020-165628

(51) Int. Cl. A63F 13/53; A63F 13/69; A63F 13/35

(52) U.S. Cl. CPC A63F 13/53; A63F 13/69; A63F 13/35

(57) ABSTRACT

When a trophy unlock condition is fulfilled, a trophy processing section 124 grants a virtual award to a user playing a game. A transmission processing section 126 transmits, to a server device 5, acquisition information regarding a trophy acquired by the user. A trophy information acquiring section 150 acquires, from the server device 5, information regarding a trophy that has a possibility of being acquired by the user next. A display processing section 140 displays the information acquired by the trophy information acquiring section 150.

### TECHNICAL FIELD

The present disclosure relates to techniques for giving virtual awards to users.

### BACKGROUND ART

For a purpose of motivating a user to play a game, a virtual award (award goods) is given to the user when the user completes a mission that is set in the game. PTL 1 discloses a game system that, when game software determines that a mission has been cleared, notifies a trophy management utility about a trophy ID (Identification) corresponding to the mission. The virtual award is called a “trophy” in PTL 1. Bronze, silver, and gold trophies are prepared according to difficulty of the mission, and when the user clears all the missions and obtains all the prepared trophies, a platinum trophy is given to the user.

### CITATION LIST

### Patent Literature

### [PTL 1]

JP 2016-97089A

### SUMMARY

### Technical Problem

Acquired trophies serve as an indicator of how well the game has been played, and users desire to acquire trophies efficiently. Therefore, it is desirable to realize a system that supports the acquisition of trophies, by providing the user with information regarding trophies that can be obtained in the future.

Accordingly, an object of the present disclosure is to implement a mechanism that supports the user in obtaining a virtual award.

### Solution to Problem

In order to solve the above problem, one aspect of the present disclosure is an information processing device that displays information regarding a virtual award to be given to a user who is playing a game when an unlock condition is satisfied, and the device includes an acquiring section that acquires information regarding a virtual award which the user has a possibility of obtaining next, and a display processing section that displays the information acquired by the acquiring section.

Another aspect of the present disclosure is, in an information processing device, a method of displaying information regarding a virtual award to be given to a user who is playing a game when an unlock condition is satisfied, and the method includes a step of acquiring information regarding the virtual award which the user has a possibility of obtaining next and a step of displaying the acquired information.

Yet another aspect of the present disclosure is a server device connected to a plurality of information processing devices operated by a plurality of users, and the server device includes an acquisition information recording section that records acquisition information related to virtual awards acquired by the plurality of users, a relation extracting section for extracting a relation regarding the order of obtaining the plurality of virtual awards on the basis of the order in which a plurality of users have obtained virtual awards, and a relation recording section for recording the extracted relation.

Yet another aspect of the present disclosure is also a server device, and the server device includes an acquisition status acquiring section that acquires the acquisition status of a virtual award acquired by a user, an identifying section for referring to the relation related to the order of acquisition of virtual awards recorded in the relation recording section and identifying a virtual award which the user has a possibility of obtaining next, and a notifying section for notifying the information processing device operated by the user about information regarding the identified virtual award.

It should be noted that any combination of the above-described components and expressions of the present disclosure converted between methods, devices, systems, recording media, computer programs, etc. are also effective as aspects of the present disclosure.

### BRIEF DESCRIPTION OF DRAWINGS

FIG. 1 is a diagram illustrating an information processing system according to an embodiment.

FIG. 2 is a diagram illustrating a hardware configuration of an information processing device.

FIG. 3 is a diagram illustrating functional blocks of the information processing device.

FIG. 4 is a diagram illustrating functional blocks of a server device.

FIG. 5 is a diagram illustrating a procedure for statistically processing collected trophy acquisition information.

FIG. 6 is a diagram illustrating an example of a calculated trophy acquisition rate.

FIG. 7 illustrates diagrams illustrating an example of a trophy acquisition history.

FIG. 8 illustrates diagrams for explaining a process of extracting a first relation.

FIG. 9 is a diagram illustrating an example of the extracted first relation.

FIG. 10 illustrates diagrams for explaining the process of extracting a second relation.

FIG. 11 is a diagram illustrating an example of the extracted second relation.

FIG. 12 is a diagram illustrating an example of a system screen.

FIG. 13 is a diagram illustrating an example of a trophy screen.

### DESCRIPTION OF EMBODIMENT

The outline of the present disclosure will be described. In the information processing system of the embodiment, a user plays game software installed in the information processing device. When an event occurs in the game, the game software outputs an event code identifying the event to the system software. An event occurs when there is a change in progress of the game play, when there is a change in an action of a game character, or the like.

Various missions are set in the game, and when the mission is cleared, the user is given a virtual award (trophy) corresponding to the mission. Since a mission clearing condition is a play condition for making the trophy available to the user, the condition is hereinafter also referred to as an “unlock condition” of a trophy. In an embodiment, game software outputs an event code, and system software determines whether the trophy unlock condition is satisfied. The system software sends acquisition information regarding unlocked trophies to an external server device.

The server device collects trophy acquisition information transmitted from a plurality of information processing devices operated by a plurality of users and analyzes play trends regarding user's trophy acquisition. In particular, the server device of the embodiment extracts the relation regarding the trophy acquisition order on the basis of the trophy acquisition information transmitted from a plurality of information processing devices. The server device provides the user with information regarding trophies which the user has a possibility of obtaining next, based on the extracted relation.

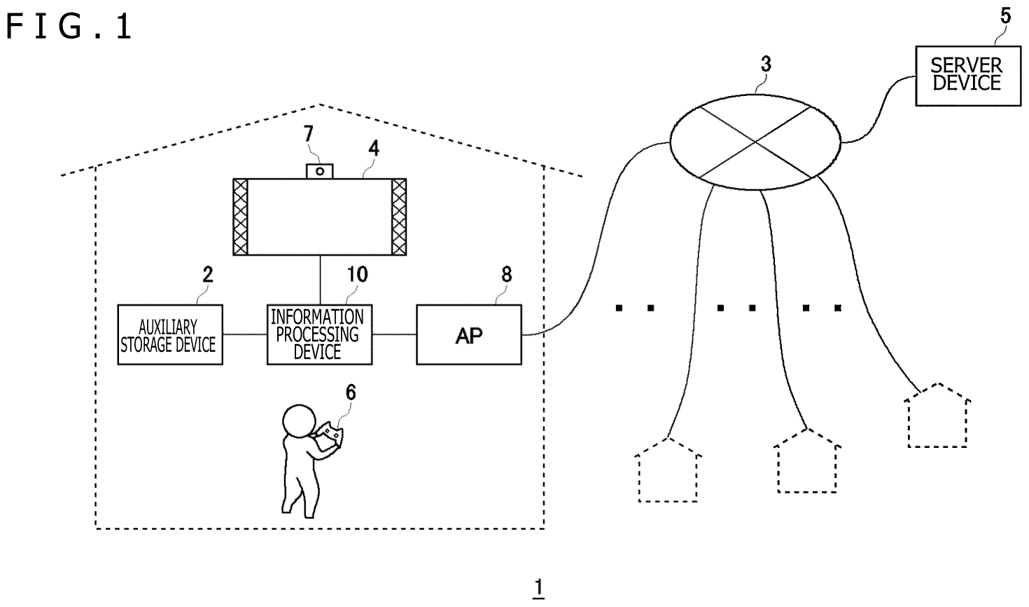

FIG. 1 illustrates an information processing system 1 according to an embodiment of the present disclosure. The information processing system 1 may be a game system including an information processing device 10 operated by a user and a server device 5. An access point (hereinafter referred to as an “AP”) 8 has the functions of a wireless access point and a router, and the information processing device 10 is connected to the AP 8 wirelessly or by wire, and is communicably connected to the server device 5 on a network 3. FIG. 1 illustrates one user and one information processing device 10, but in the information processing system 1, it is assumed that a plurality of information processing devices 10 operated by a plurality of users and the server device 5 are connected via the network 3.

The information processing device 10 is wirelessly or by wire connected to an input device 6 operated by a user, and the input device 6 outputs information regarding operation by the user to the information processing device 10. When receiving operation information from the input device 6, the information processing device 10 reflects the operation information in the processing of the system software and the game software, and causes an output device 4 to output the processing result. In the information processing system 1, the information processing device 10 may be a game device (game console) that executes a game, and the input device 6 may be a device such as a game controller that supplies user operation information to the information processing device 10. Incidentally, the input device 6 may be an input interface such as a keyboard or mouse.

An auxiliary storage device 2 is a large-capacity recording device such as an HDD (Hard Disk Drive) or an SSD (Solid State Drive), and may be a built-in recording device and may be an external recording device connected to the information processing device 10 via a USB (Universal Serial Bus) or the like. The output device 4 may be a television having a display for outputting images and a speaker for outputting sounds. The output device 4 may be connected to the information processing device 10 with a wired cable or may be wirelessly connected.

A camera 7, which is an imaging device, is provided near the output device 4 and captures an image of the space around the output device 4. Although FIG. 1 illustrates an example in which the camera 7 is attached to a top of the output device 4, the camera 7 may be placed on the side or bottom of the output device 4, and in any case, is arranged at a position, so that the user positioned in front of the output device 4 can be imaged. The camera 7 may be a stereo camera.

The server device 5 provides network services to users of the information processing system 1. The server device 5 manages network accounts that identify respective users, and each user uses the network account to sign in to network services provided by the server device 5. By signing in to the network service from the information processing device 10, the user can register saved game data and trophies that are virtual awards obtained during game plays, in the server device 5. By registering the saved data and the trophies in the server device 5, even if the user uses an information processing device other than the information processing device 10, the saved data and the trophies can be synchronized.

The server device 5 of the embodiment collects acquisition information of trophies acquired by a plurality of users from a plurality of information processing devices 10. The server device 5 analyzes play trends related to trophy acquisition from the collected trophy acquisition information. The server device 5 can use the analysis results related to the trophy acquisition to identify the trophies that the user is likely to acquire next, based on the user's trophy acquisition record up to the present. The server device 5 notifies the user about the trophies that are likely to be obtained next, so that the user can play the game with an awareness of obtaining the trophy.

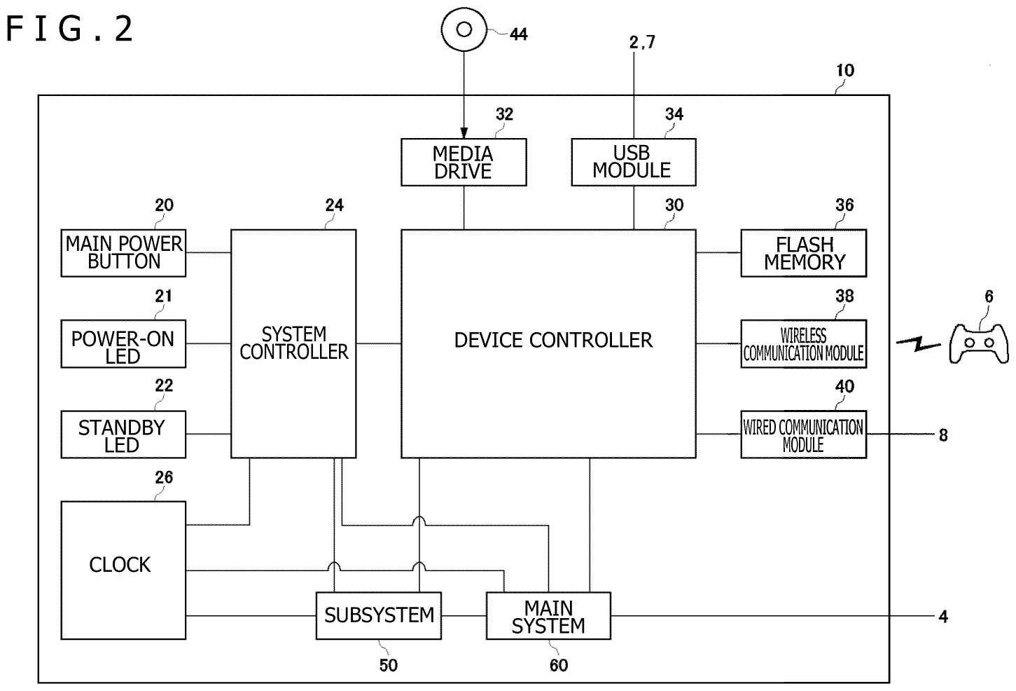

FIG. 2 illustrates the hardware configuration of the information processing device 10. The information processing device 10 includes a main power button 20, a power-ON LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main CPU (Central Processing Unit), a memory that is a main storage device, a memory controller, a GPU (Graphics Processing Unit), and the like. The GPU is mainly used for arithmetic processing of game programs. The main CPU has the function of activating the system software and executing the game program installed in the auxiliary storage device 2 under the environment provided by the system software. The subsystem 50 includes a sub-CPU, a memory that is a main storage device, a memory controller, and the like, and does not include a GPU.

The main CPU has the function of executing a game program installed in the auxiliary storage device 2, whereas the sub-CPU does not have such a function. However, the sub-CPU has a function of accessing the auxiliary storage device 2 and a function of transmitting/receiving data to/from the management server 5. The sub-CPU is configured to have only such limited processing functions, and therefore can operate with lower power consumption than the main CPU. These sub-CPU functions are executed when the main CPU is in the standby state.

The main power button 20 is an input unit for inputting an operation from the user, and is provided on the front surface of the housing of the information processing device 10, to be operated to turn on or off the power supply to the main system 60 of the information processing device 10. The power-ON LED 21 lights up when the main power button 20 is turned on, and the standby LED 22 lights up when the main power button 20 is turned off. The system controller 24 detects pressing of the main power button 20 by the user.

The clock 26 is a real-time clock that generates information regarding current date and time and supplies the information to the system controller 24, the subsystem 50, and the main system 60.

The device controller 30 is configured as an LSI (Large-Scale Integrated Circuit) that exchanges information between devices like a south bridge. As illustrated, devices such as the system controller 24, the media drive 32, the USB module 34, the flash memory 36, the wireless communication module 38, the wired communication module 40, the subsystem 50, and the main system 60 are connected to the device controller 30. The device controller 30 absorbs differences in electrical characteristics and data transfer speeds of the respective devices, and controls the timing of data transfer.

The media drive 32 is a drive device on which a ROM medium 44 that records application software of games or the like and license information is mounted, and which drives the ROM medium 44 to read programs, data, and the like from the ROM medium 44. The ROM medium 44 is a read-only recording medium such as an optical disk, a magneto-optical disk, or a Blu-ray disk.

The USB module 34 is a module that connects to an external device with a USB cable. The USB module 34 may be connected to the auxiliary storage device 2 or the camera 7 with a USB cable. The flash memory 36 is an auxiliary storage device that constitutes an internal storage. The wireless communication module 38 wirelessly communicates with, for example, the input device 6 by using a communication protocol such as the Bluetooth (registered trademark) protocol or the IEEE (Institute of Electrical and Electronics Engineers) 802.11 protocol. The wired communication module 40 performs wired communication with external devices and connects to the network 3 via the AP 8, for example.

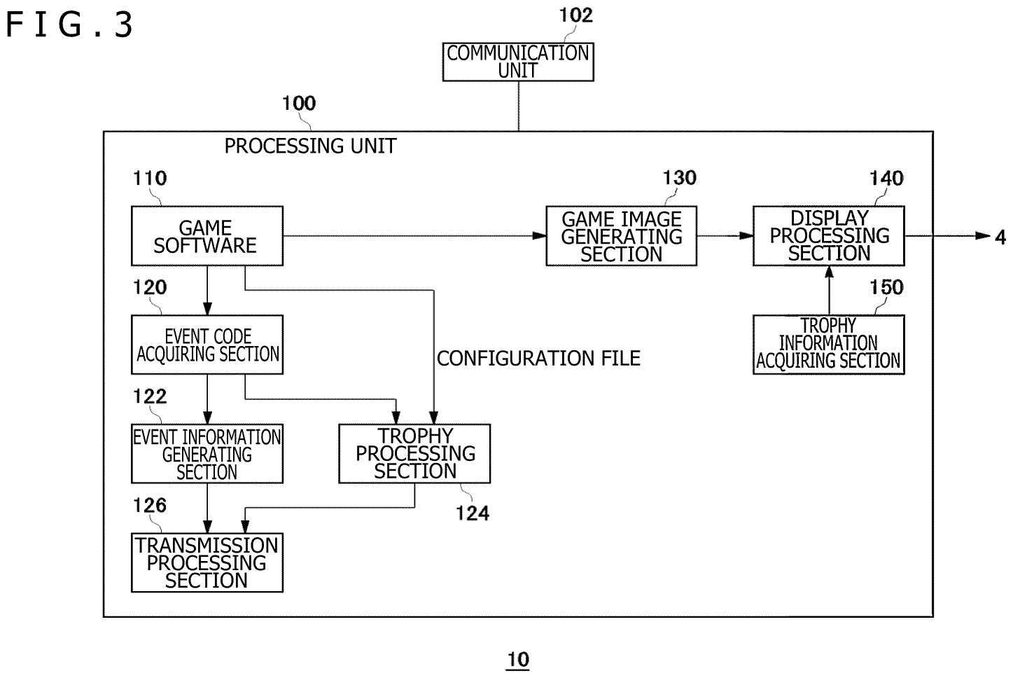

FIG. 3 illustrates functional blocks of the information processing device 10. The information processing device 10 includes a processing unit 100 and a communication unit 102. The processing unit 100 includes a game software 110, an event code acquiring section 120, an event information generating section 122, a trophy processing section 124, a transmission processing section 126, a game image generating section 130, a display processing section 140, and a trophy information acquiring section 150.

Respective elements described as functional blocks that perform various processes of the information processing device 10 in FIG. 3 can be constituted by circuit blocks, memories, and other LSIs in terms of hardware, and can be implemented by programs loaded in memory in terms of software. Therefore, those skilled in the art will understand that these functional blocks can be achieved in various forms by hardware only, software only, or a combination thereof, and are not limited to either one.

The game software 110 includes at least a game program, image data, sound data, and a configuration file. The game program receives operation information of the input device 6 operated by the user and performs arithmetic processing to move the game character in the virtual space. The game image generating section 130 includes a GPU (Graphics Processing Unit) that executes rendering processing and the like, and generates game image data. Note that the processing unit 100 includes a sound data generating section that generates game sound data, but the section is omitted in FIG. 3. The display processing section 140 outputs the game image from the output device 4.

When an event occurs during the progress of the game, the game program outputs an event code indicating the event that has occurred. The event code acquiring section 120 acquires the event code from the game software 110 and provides the code to the event information generating section 122 and the trophy processing section 124. The event information generating section 122 generates event information in which time information (time stamp) indicating the time of the event occurrence is added to the event code, and provides the event information to the transmission processing section 126. The transmission processing section 126 transmits the generated event information to the server device 5.

A game developer may program various events into the game. An event code is assigned to each event, and the game program may add game data indicating the state of the game at the time of the event occurrence to the event code indicating the event that has occurred, and output the event code. Here, the game data includes the place where the event has occurred, peripheral information regarding opponents, objects, and the like. For example, when a battle with an enemy boss starts, the game program may output an event code indicating the start of the battle, with game data indicating the location of the battle and the character ID of the enemy boss attached to the code.

Various missions are set in the game for the purpose of motivating the user to play the game, and when the user clears the mission, the user is given a virtual award (trophy) corresponding to the mission. In the game, a plurality of types of trophies are prepared according to the difficulty of the mission, and bronze, silver, gold, and platinum trophies are prepared in ascending order of difficulty.

The configuration file included in the game software 110 describes a correspondence relation between event codes output from the game and conditions for unlocking trophies. For example, the configuration file states that the “defeat the little boss” event is a condition for unlocking the bronze trophy. Similarly, the configuration file states that the “defeat the middle boss” event is a condition for unlocking the silver trophy, and that the “defeat the final boss” event is a condition for unlocking the gold trophy.

When the event code is provided from the event code acquiring section 120, the trophy processing section 124 refers to the configuration file and performs a fulfillment determination process of a trophy unlock condition. When determining that the unlock condition is satisfied, the trophy processing section 124 generates acquisition information of the unlocked trophy and provides the information to the transmission processing section 126. The trophy acquisition information includes identification information for identifying the game (game ID), identification information for identifying the unlocked trophy (trophy ID), and information regarding unlocking time (time stamp).

The transmission processing section 126 transmits the generated trophy acquisition information to the server device 5. In the information processing system 1, the process of transmitting the trophy acquisition information is performed by all the information processing devices 10 connected to the server device 5, and the server device 5 collects various game trophy acquisition information from the plurality of information processing devices 10. The information processing device 10 preferably transmits trophy acquisition information to the server device 5 immediately after acquiring a trophy.

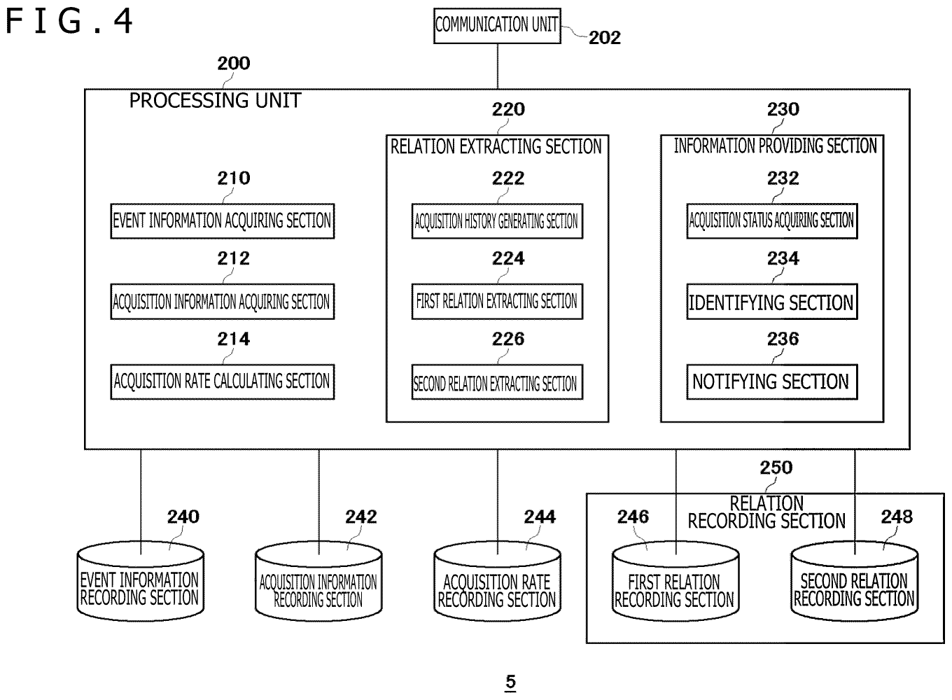

FIG. 4 illustrates functional blocks of the server device 5. The server device 5 includes a processing unit 200, a communication unit 202, an event information recording section 240, an acquisition information recording section 242, an acquisition rate recording section 244 and a relation recording section 250. The relation recording section 250 has a first relation recording section 246, and a second relation recording section 248. The processing unit 200 includes an event information acquiring section 210, an acquisition information acquiring section 212, an acquisition rate calculating section 214, a relation extracting section 220, and an information providing section 230. The relation extracting section 220 has an acquisition history generating section 222, a first relation extracting section 224, and a second relation extracting section 226. The information providing section 230 has an acquisition status acquiring section 232, an identifying section 234, and a notifying section 236.

Respective elements described as functional blocks that perform various processes of the server device 5 in FIG. 4 is achieved by circuit blocks, memories, and other LSIs in terms of hardware, and by programs loaded in memory, etc. in terms of software. Accordingly, those skilled in the art will understand that these functional blocks can be achieved in various forms by hardware only, software only, or a combination thereof, and are not limited to either one.

The event information acquiring section 210 acquires event information from a plurality of information processing devices 10 operated by a plurality of users, and records the event information in the event information recording section 240. The event information recording section 240 records event information for each game title in association with the user's network account. The server device 5 may analyze the event information to analyze the game play trends of the users.

The acquisition information acquiring section 212 acquires trophy acquisition information from a plurality of information processing devices 10 operated by a plurality of users, and records the information in the acquisition information recording section 242. The acquisition information recording section 242 records trophy acquisition information for each game title in association with the user's network account. As described above, the trophy acquisition information includes information regarding a game ID, a trophy ID, and a time stamp. A procedure of the server device 5 for statistically processing the collected trophy acquisition information and extracting relation information relating to the trophy acquisition order will be described below.

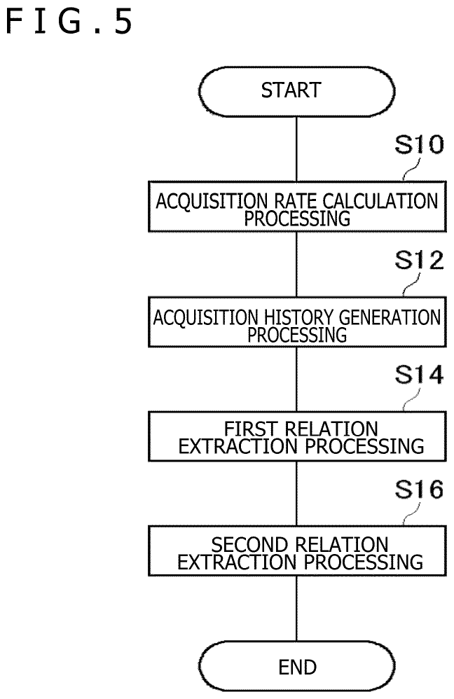

FIG. 5 illustrates a procedure for statistically processing the collected trophy acquisition information. The statistical processing of the trophy acquisition information includes acquisition rate calculation processing by the acquisition rate calculating section 214 (S10), acquisition history generation processing by the acquisition history generating section 222 (S12), first relation extraction processing by the first relation extracting section 224 (S14), and a second relation extraction processing by the second relation extracting section 226 (S16). This statistical processing is performed periodically for each game title, for example, once a day.

### <S10: Acquisition Rate Calculation Processing>

The acquisition rate calculating section 214 calculates the acquisition rate for each trophy. The trophy acquisition rate is calculated as a value between 0% and 100%, and is obtained by the following equation.

Trophy acquisition rate=(number of trophy winners/total number of players in the game)×100

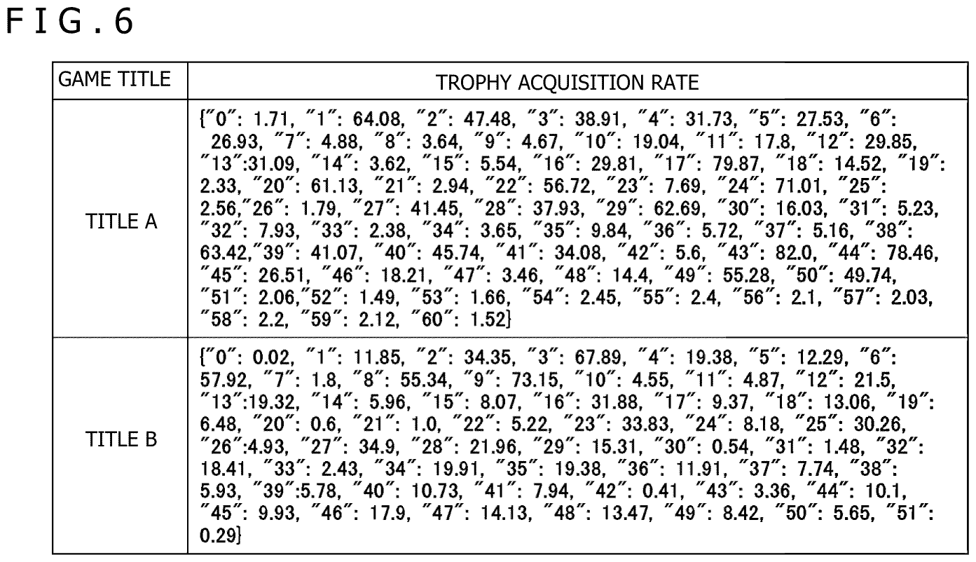

FIG. 6 illustrates an example of a calculated trophy acquisition rate. The trophy acquisition rate is calculated for each trophy ID. It should be noted that the trophy represented by a trophy ID “0” is a platinum trophy given to users who have acquired all trophies, and trophies of trophy ID 1 or higher are trophies that correspond to missions set during the game.

In the example illustrated in FIG. 6, for game title A, 60 trophies are set, and for game title B, 51 trophies are set. The calculated acquisition rate may be presented to the user as an index indicating the degree of difficulty in acquiring trophies. The acquisition rate calculating section 214 records the calculated trophy acquisition rate in the acquisition rate recording section 244.

Hereinafter, a process of extracting a relation regarding the acquisition order of trophies by the relation extracting section 220 on the basis of the order in which a plurality of players have acquired a plurality of trophies for one game title will be described.

### <S12: Acquisition History Generation Processing>

The acquisition history generating section 222 sorts the trophy IDs acquired by the player by the trophy acquisition time (time stamp) and generates a trophy acquisition history in which the trophy IDs are arranged in order of acquisition. The acquisition history generating section 222 generates a trophy acquisition history for each player on the basis of the time stamp included in the trophy acquisition information recorded in the acquisition information recording section 242.

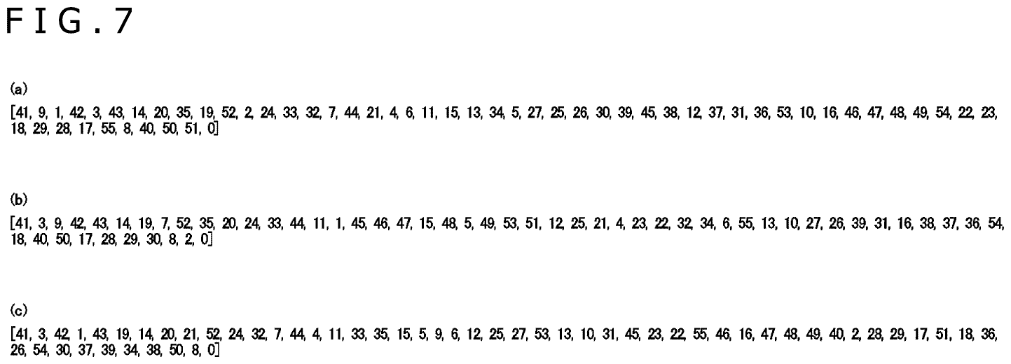

(a) to (c) of FIG. 7 illustrate examples of trophy acquisition histories of three players. In each trophy acquisition history, the first trophy ID indicates the first trophy acquired by the player, and the last trophy ID indicates the last trophy acquired by the player. There are 55 trophies prepared for this game title, and all players have obtained all 55 trophies and have been given platinum trophies.

In the trophy acquisition histories illustrated in (a) to (c) of FIG. 7, the trophy with trophy ID 41 is acquired first in any history. In this game, the trophy with trophy ID 41 is set in the game tutorial, and all players obtain the trophy with trophy ID 41 by taking the tutorial when they start the game for the first time.

In the trophy acquisition history illustrated in (a) of FIG. 7, the situation in which trophies have been acquired in order of ID 9, ID 1, ID 42, . . . after trophy ID 41 is illustrated. Also, in the trophy acquisition history illustrated in (b) of FIG. 7, the situation in which trophies have been acquired in order of ID 3, ID 9, ID 42, . . . after trophy ID 41 is illustrated. Also, in the trophy acquisition history illustrated in (c) of FIG. 7, the situation in which trophies have been acquired in order of ID 3, ID 42, ID 1, . . . after trophy ID 41 is illustrated.

The acquisition history generating section 222 generates trophy acquisition histories of all players of the game. Incidentally, although (a) to (c) of FIG. 7 illustrate the histories of acquiring all trophies, the history of acquiring trophies naturally includes the history of acquiring some trophies as well. Note that, in the case where the total number of players is large, the acquisition history generating section 222 may generate trophy acquisition histories of a predetermined number of players (for example, 1,000,000) in order to reduce the processing load. The acquisition history generating section 222 supplies the generated trophy acquisition histories of a plurality of players to the first relation extracting section 224 and the second relation extracting section 226.

### <S14: First Relation Extraction Processing>

The first relation extracting section 224 extracts, for at least one trophy, a first relation that determines trophies that need to be obtained before obtaining the trophy. In other words, this first relation determines trophies that must be obtained in advance in the case of attempting to obtain a certain trophy. For example, in the trophy acquisition history illustrated in (a) to (c) of FIG. 7, the trophy with trophy ID 41 is acquired first, and this means that the trophy with trophy ID 41 must be obtained before obtaining a trophy other than the trophy with trophy ID 41. The first relation extracting section 224 extracts such dependence relations from a plurality of trophy acquisition histories supplied from the acquisition history generating section 222.

The first relation extracting section 224 extracts, for each of all trophies, the first relation that determines trophies that need to be obtained before obtaining the trophy. Hereinafter, as an example, processing for extracting the first relation regarding trophy ID 42 will be described.

First, the first relation extracting section 224 identifies the trophy acquisition history of the player who has acquired the trophy ID 42, and deletes the trophy IDs acquired after the trophy ID 42 from the trophy acquisition history.

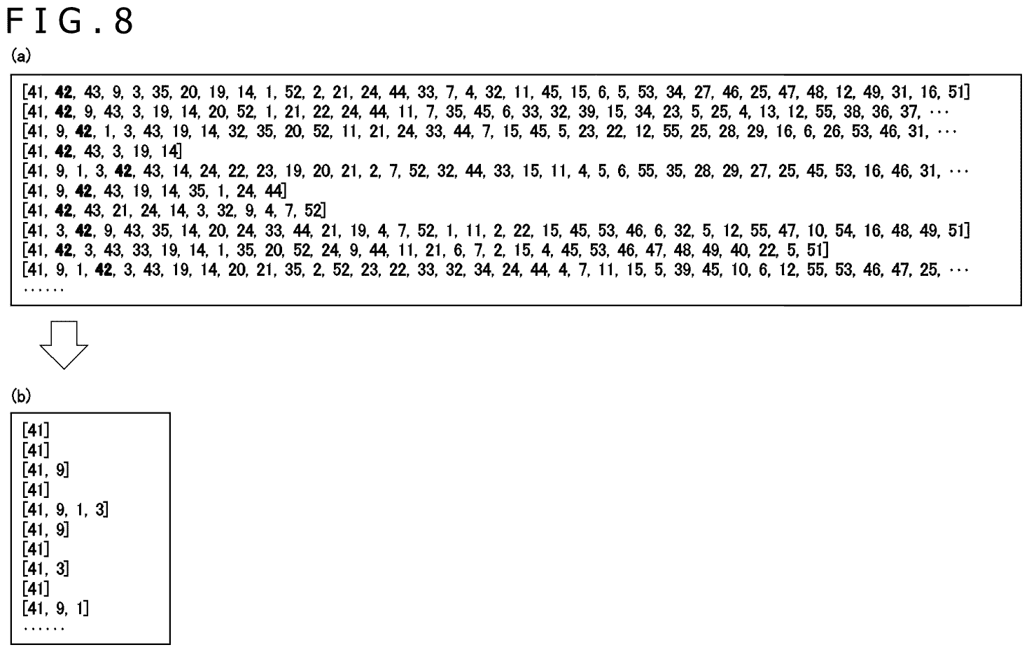

(a) and (b) of FIG. 8 are diagrams for explaining the process of extracting the first relation. (a) of FIG. 8 illustrates an example of acquisition histories of a plurality of trophies including trophy ID 42. The first relation extracting section 224 deletes the list after the target trophy ID 42 in the trophy acquisition history. (b) of FIG. 8 illustrates an example of trophy IDs acquired before acquiring trophy ID 42. That is, the trophy ID group illustrated in (b) of FIG. 8 is the trophy ID group that has already been acquired when the trophy ID 42 is acquired.

The first relation extracting section 224 extracts trophy IDs commonly included in all trophy ID groups. Referring to (b) of FIG. 8, all trophy ID groups include trophy ID 41. Therefore, the first relation extracting section 224 understands that it is necessary to acquire the trophy with the trophy ID 41 before acquiring the trophy with the trophy ID 42.

The first relation extracting section 224 extracts, for each of all trophies, a first relation that determines one or more trophies that need to be obtained before obtaining the trophy. It should be noted that the first relation extracting section 224 may exclude trophies acquired by a very small number of players from the targets of the first relation extraction processing. Further, the first relation extracting section 224 may exclude acquisition histories suspected of fraudulence on the basis of the order of trophy acquisition from the targets of the first relation extraction processing. The first relation extracting section 224 records the extracted first relation in the first relation recording section 246 for each game title.

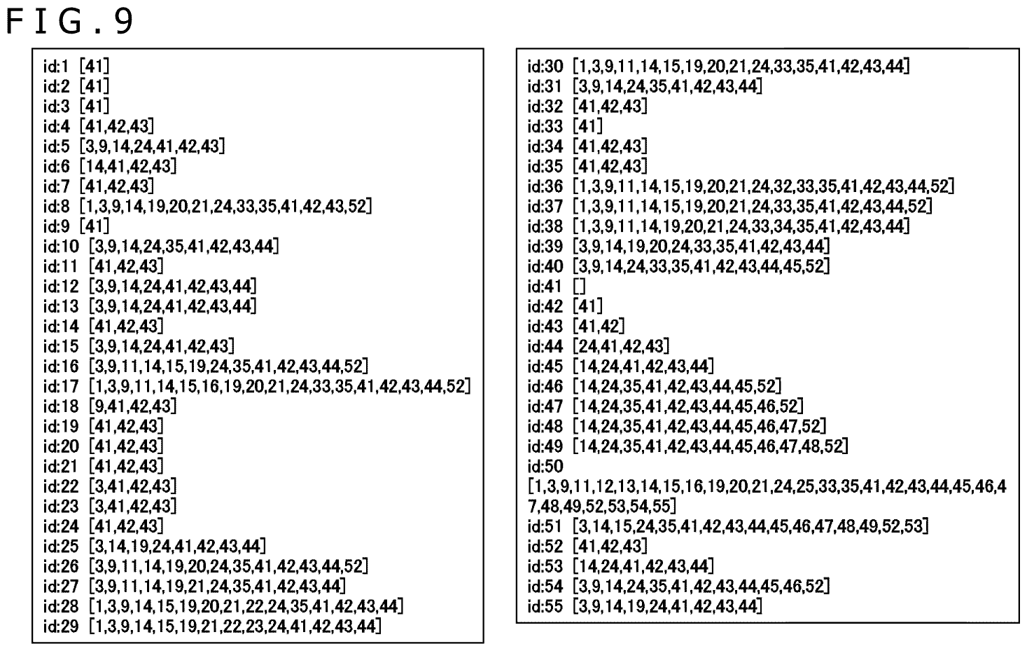

FIG. 9 illustrates an example of extracted first relations. The first relation illustrated in FIG. 9 determines, for each of all trophies, trophies that need to be acquired before the acquisition of the trophy. For example, trophy IDs 41, 42, and 43 are set for trophy ID 4, and this means that the trophies with trophy IDs 41, 42, and 43 need to be already acquired in order to acquire the trophy with trophy ID 4. Incidentally, another trophy ID is not set for trophy ID 41, which means that it is not necessary to obtain another trophy when obtaining the trophy with the trophy ID 41.

The trophies with trophy IDs 1, 2, 3, 9, 33, and 42 for which only the trophy ID 41 is set can be acquired as long as the trophy with the trophy ID 41 has already been acquired. Therefore, the player who has acquired the trophy ID 41 can acquire the trophies with trophy IDs 1, 2, 3, 9, 33, and 42 next. On the other hand, for trophy ID 50, a trophy ID group of trophy IDs 1, 3, 9, 11, 12, 13, 14, 15, 16, 19, 20, 21, 24, 25, 33, 35, 41, 42, 43, 44, 45, 46, 47, 48, 49, 52, 53, 54, and 55 is set. This means that in order to obtain the trophy with trophy ID 50, all the set trophies need to be obtained before that.

### <S16: Second Relation Extraction Processing>

The second relation extracting section 226 extracts, for at least one trophy, a second relation that determines trophies that have been acquired after acquisition of the trophy. That is, this second relation determines, for a certain trophy, the trophies that have been won next to the trophy. The second relation extracting section 226 extracts such a correspondence relation from a plurality of trophy acquisition histories supplied from the acquisition history generating section 222.

The second relation extracting section 226 extracts, for each of all trophies, a second relation that determines a trophy that have been won subsequent to the acquisition of the trophy. Hereinafter, as an example, processing for extracting the second relation regarding trophy ID 42 will be described.

First, the second relation extracting section 226 identifies the trophy acquisition history of the player who has acquired the trophy ID 42, and identifies the trophy ID acquired immediately after the trophy ID 42 from the trophy acquisition history.

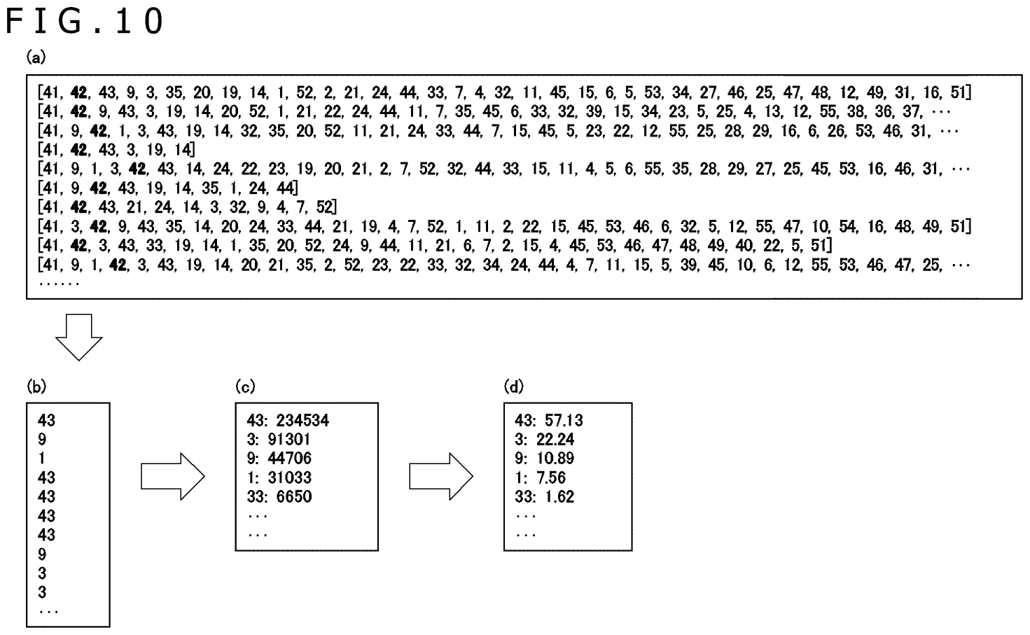

(a) to (d) of FIG. 10 are diagrams for explaining the process of extracting the second relation. (a) of FIG. 10 illustrates an example of the acquisition histories of a plurality of trophies including the trophy ID 42. The second relation extracting section 226 identifies the trophy ID immediately after the trophy ID 42 that is a target in the trophy acquisition history. (b) of FIG. 10 illustrates an example of trophy IDs listed next to trophy ID 42 in the trophy acquisition history.

The second relation extracting section 226 adds up the numbers of trophy IDs following the trophy ID 42. (c) of FIG. 10 illustrates the aggregate result of the identified trophy IDs. Note that (c) of FIG. 10 illustrates the top five aggregate results with a large total number, but aggregate results for the top six or more may be derived. (d) of FIG. 10 illustrates the acquisition rate derived from the aggregate result. This example indicates that 57.13% of the players who had won the trophy with trophy ID 42 won the trophy with trophy ID 43 next. This means that after the player has won the trophy with trophy 42, it is easy for the player to obtain the trophy with trophy ID 43.

The second relation extracting section 226 extracts, for each of all trophies, a second relation that determines the trophies acquired subsequent to the acquisition of the trophy and their acquisition rates. It should be noted that the second relation extracting section 226 may exclude trophies acquired by a very small number of players from the target of the second relation extraction processing. Further, the second relation extracting section 226 may exclude acquisition histories suspected of fraudulence on the basis of the acquisition order of the trophies from the target of the second relation extraction processing. The second relation extracting section 226 records the extracted second relation in the second relation recording section 248 for each game title.

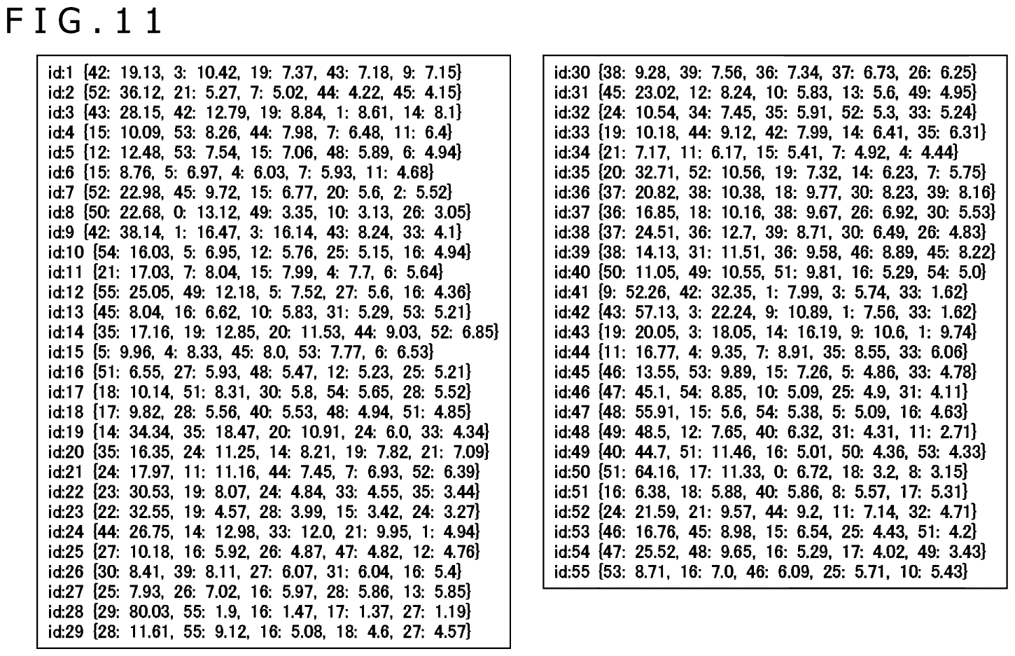

FIG. 11 illustrates an example of the extracted second relation. The second relation illustrated in FIG. 11 determines, for each of all trophies, trophies to be won next to the trophy and their acquisition rates. This second relation indicates that, for example, after winning the trophy with trophy ID 42, 57.13% of the players have won the trophy with trophy ID 43, 22.24% of the players have won the trophy with trophy ID 3, 10.89% of the players have won the trophy with trophy ID 9, 7.56% of the players have won the trophy with trophy ID 1, and 1.62% of the players have won the trophy with trophy ID 33. From this analysis, it is found that a player who has won the trophy with trophy ID 42 is likely to win the trophy with trophy ID 43 next.

As described above, the acquisition rate calculating section 214 and the relation extracting section 220 periodically perform the statistical processing illustrated in FIG. 5, and record the processing result in the acquisition rate recording section 244 and the relation recording section 250. The information providing section 230 refers to the statistical data recorded in the acquisition rate recording section 244 and the relation recording section 250, and provides the user with information regarding the trophies that have a possibility of being obtained next.

In the information processing device 10, when the user acquires a trophy during game play, the transmission processing section 126 transmits the trophy acquisition information to the server device 5. In the server device 5, when the acquisition information acquiring section 212 acquires the trophy acquisition information, the acquisition status acquiring section 232 acquires the acquisition status of trophies acquired by the user in the same game. Here, the acquisition status acquiring section 232 acquires information identifying a trophy (trophy ID) acquired by the user in the past from the acquisition information recording section 242 as the acquisition status. The acquisition status acquiring section 232 provides the identifying section 234 with the trophy ID of the trophy currently acquired by the user and the trophy ID of the trophy acquired in the past.

The identifying section 234 refers to the relation related to the trophy acquisition order recorded in the relation recording section 250 to identify a trophy that the user has a possibility of acquiring next. To be specific, the identifying section 234 identifies one or more trophies that can be obtained next on the basis of the trophies that have been obtained by then, and derives the obtainability of the identified one or more trophies.

### <Identifying Processing of the Next Acquirable Trophy>

The identifying section 234 refers to the first relation and identifies one or more trophies that can be acquired next from the trophies that the user has acquired by this time. For example, in the case where the user has acquired trophies with trophy IDs 41, 42, and 43, the identifying section 234 refers to the first relation illustrated in FIG. 9, and finds that the trophies with trophy IDs 1, 2, 3, 4, 7, 9, 11, 14, 19, 20, 21, 24, 32, 33, 34, 35, and 52 are obtainable next. Note that when identifying the group of trophies that can be acquired next, based on the first relation, the identifying section 234 excludes trophies that have already been acquired, and therefore the trophies with trophy IDs 41, 42, and 43 are not included in the trophy group.

### <Derivation Processing of Trophy Acquirability>

The identifying section 234 derives the possibility of obtaining a trophy from among the next obtainable trophies by referring to the second relation. In the case where the trophy with trophy ID 43 is the most recently acquired among the acquired trophy IDs 41, 42, and 43, the identifying section 234 refers to the second relation determined for trophy ID 43, and identifies trophies having a relatively high possibility of being won by the user next. To be specific, the identifying section 234 refers to the second relation illustrated in FIG. 11, and identifies trophy IDs 19, 3, 14, 9, and 1 associated with trophy ID 43, thereby determining whether these trophy IDs are included in the group of next obtainable trophies. In this example, since trophy IDs 19, 3, 14, 9, and 1 are included in the trophy group, the identifying section 234 identifies trophies with trophy IDs 19, 3, 14, 9, and 1 as trophies having a high possibility of being obtained next.

The notifying section 236 notifies the user's information processing device 10 about information regarding the identified trophies. The notifying section 236 may give only the information regarding a trophy that the user is most likely to acquire next. In this case, the acquisition rate of trophy ID 19 is the highest, so that the notifying section 236 notifies the information processing device 10 about the information regarding the trophy with trophy ID 19.

Note that the identifying section 234 may perform a scoring process for giving scores to the next obtainable trophies, and the notifying section 236 may notify the information processing device 10 about information regarding the trophy given the highest score. The score reflects at least the acquisition rate obtained from the second relation, and may further reflect the acquisition rate recorded in the acquisition rate recording section 244. Since the acquisition rate recorded in the acquisition rate recording section 244 serves as an index of ease with which a trophy can be obtained, the score is preferably calculated so as to be linked to the level of the acquisition rate. In other words, it is preferable that trophies with high acquisition rates recorded in the acquisition rate recording section 244 have relatively high calculated scores, and trophies with low acquisition rates have relatively low calculated scores. Note that the identifying section 234 can also calculate scores according to the trophy types of bronze, silver, and gold.

In the information processing device 10, the trophy information acquiring section 150 acquires information regarding trophies which the user may acquire next, from the server device 5. The display processing section 140 displays the information acquired by the trophy information acquiring section 150.

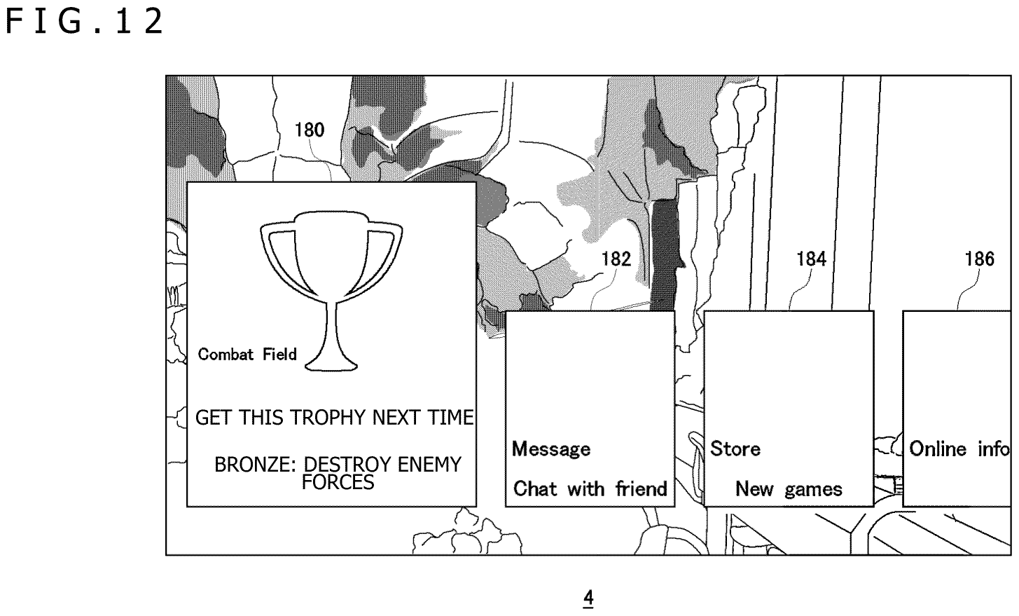

FIG. 12 illustrates an example of a system screen. When the user operates a predetermined button of the input device 6 while playing the game title “Combat Field,” the display processing section 140 generates system images 180, 182, 184 and 186 and superimposes the images on the game screen. The system image is a GUI (Graphical User Interface) that gives information regarding applications that are active in the information processing device 10 or information that is presumed to have high priority for the user.

Here, the system image 180 includes information regarding trophy acquisition for the game title “Combat Field.” The trophy information acquiring section 150 acquires information regarding trophies from the server device 5, and the display processing section 140 displays the system image 180 including information regarding trophies to be acquired next. Note that the display processing section 140 may display the system image 180 including information regarding the acquisition of trophies in “Combat Field” on condition that the user is playing “Combat Field.” In this example, the message “Get this trophy next time” is displayed together with the image of the trophy as information indicating the presence of the possibility of winning the trophy. The trophy recommended for acquisition in the system image 180 is preferably the trophy having the highest possibility of being acquired. This allows the user to recognize a trophy that are likely to be obtained, and play the game so as to win the trophy.

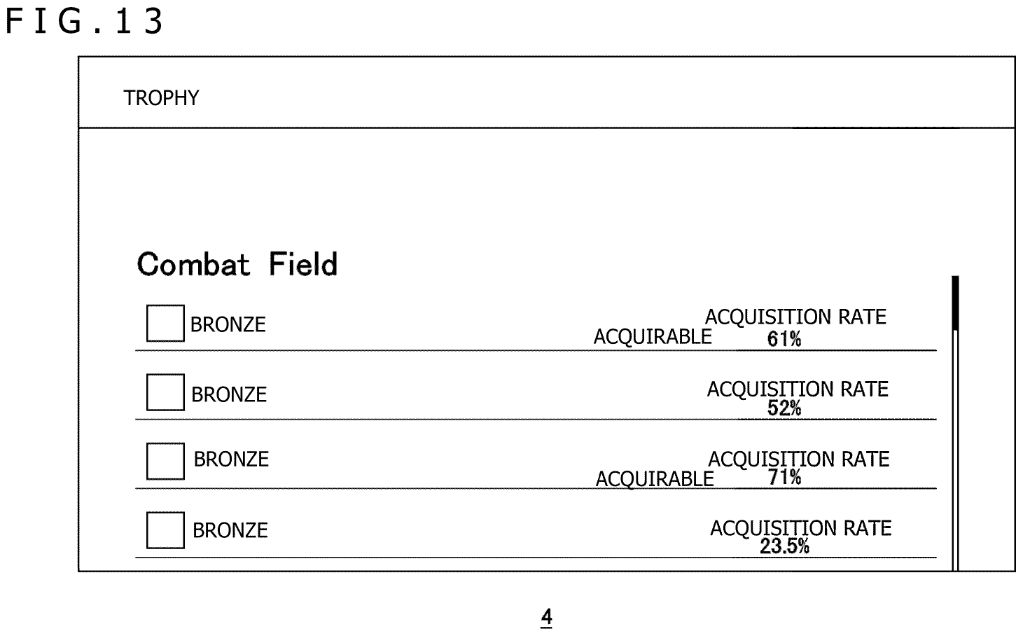

FIG. 13 illustrates an example of a trophy screen displaying a list of trophies that have not been acquired. In response to a request from the information processing device 10, the server device 5 may transmit information as to whether or not the unacquired trophies are available for acquisition to the information processing device 10. To be specific, the identifying section 234 refers to the first relation illustrated in FIG. 9, and identifies the group of trophies that can be acquired next from the trophy acquisition status, and the notifying section 236 notifies the information processing device 10 about the group of trophies. As a result, the display processing section 140 can add information indicating whether or not trophies can be acquired at present when displaying a list of unacquired trophies.

The present disclosure has been described above based on the embodiments. It should be understood by those skilled in the art that this embodiment is an example, and that various modifications can be made to combinations of respective components and respective treatment processes, and such modifications are within the scope of the present disclosure.

### INDUSTRIAL APPLICABILITY

The present disclosure can be used for technology in which virtual awards are provided to users.

### REFERENCE SIGNS LIST

1: Information processing system
5: Server device
10: Information processing device
100: processing unit
102: Communication unit
110: Game software
120: Event code acquiring section
122: Event information generating section
124: Trophy processing section
126: Transmission processing section
130: Game image generating section
140: Display processing section
150: Trophy information acquiring section
200: Processing unit
202: Communication unit
210: Event information acquiring section
212: Acquisition information acquiring section
214: Acquisition rate calculating section
220: Relation extracting section
222: Acquisition history generating section
224: First relation extracting section
226: Second relation extracting section
230: Information providing section
232: Acquisition status acquiring section
234: Identifying section
236: Notifying section
240: Event information recording section
242: Acquisition information recording section
244: Acquisition rate recording section
246: First relation recording section
248: Second relation recording section
250: Relation recording section

1. An information processing device that displays information regarding a virtual award to be given to a user who is playing a game when an unlock condition is satisfied, the information processing device comprising:
an acquiring section that acquires information regarding the virtual award that the user has a possibility of acquiring next; and
a display processing section that displays the information acquired by the acquiring section.

2. The information processing device according to claim 1, wherein
when displaying the virtual award, the display processing section displays the virtual award together with information indicating that there is a possibility of acquiring the virtual award.

3. The information processing device according to claim 1, wherein
the display processing section displays information regarding the virtual award that has a highest possibility of being acquired.

4. A method for displaying information regarding a virtual award to be given to a user who is playing a game when an unlock condition is satisfied in an information processing device, the method comprising:
acquiring information regarding the virtual award that the user has a possibility of acquiring next; and
displaying the acquired information.

5. A server device connected to a plurality of information processing devices operated by a plurality of users, the server comprising:
an acquisition information recording section that records acquisition information related to virtual awards acquired by the plurality of users;
a relation extracting section that extracts a relation regarding an acquisition order of the plurality of virtual awards, based on an order of acquisition of the virtual awards by the plurality of users; and
a relation recording section that records the extracted relation.

6. The server device according to claim 5, wherein
the relation extracting section extracts, for one virtual award, a first relation that determines a virtual award that needs to be acquired before the one virtual award is acquired.

7. The server device according to claim 6, wherein
the first relation determines, for all virtual awards, a virtual award that need to be acquired before each of the all virtual awards is acquired.

8. The server device according to claim 5, wherein
the relation extraction section extracts, for one virtual award, a second relation that determines a virtual award acquired subsequent to acquisition of the one virtual award.

9. The server device according to claim 8, wherein
the second relation determines, for one virtual award, an acquisition rate of a virtual award acquired subsequent to acquisition of the one virtual award.

10. The server device according to claim 8, wherein
the second relation determines, for all virtual awards, a virtual award acquired subsequent to acquisition of each of the all virtual awards.

11. A server device comprising:
an acquisition status acquiring section that acquires an acquisition status of a virtual award acquired by a user;
an identifying section that refers to a relation related to an order of acquisition of virtual awards recorded in a relation recording section, and identifies a virtual award that the user has a possibility of acquiring next; and
a notifying section that notifies the information processing device operated by the user about information regarding the identified virtual award.

12. The server device according to claim 11, wherein
the identifying section identifies a virtual award that has a relatively high possibility of being acquired next by the user by referring to the relation determined for a virtual award most recently acquired by the user.

13. The server device according to claim 11, wherein
the notifying section gives information regarding a virtual award that the user has a highest possibility of acquiring next.

14. The server device according to claim 11, further comprising:
an acquisition information acquiring section that acquires acquisition information related to a virtual award acquired by the user from the information processing device operated by the user, wherein
when the acquisition information acquiring section acquires the acquisition information, the acquisition status acquiring section acquires, as the acquisition status, information identifying a virtual award that the user has acquired in a past.
